(19) United States
(12) Patent Application Publication
(10) Pub. No.: US 2011/0083192 A1
(43) Pub. Date: Apr. 7, 2011

(54) IMAGE PROCESSING APPARATUS, CONTROL METHOD THEREOF, AND COMPUTER-READABLE STORAGE MEDIUM

(75) Inventor: Yutaka Tokura, Ebina-shi (JP)

(73) Assignee: CANON KABUSHIKI KAISHA, Tokyo (JP)

(21) Appl. No.: 12/892,773

(22) Filed: Sep. 28, 2010

(30) Foreign Application Priority Data
Oct. 1, 2009 (JP) 2009-229465

(51) Int. Cl. G06F 21/24

(52) U.S. Cl. 726/26

(57) ABSTRACT

An apparatus includes a data reception unit configured to receive print data containing a first password including a password corresponding to at least a printing request of the print data and store the print data; an encryption determination unit configured to determine, when an external apparatus makes a printing request of the print data, whether the print data has been encrypted; a password request unit configured to make, when the print data is determined to have been encrypted, an input request of a second password to the external apparatus; a password collation unit configured to collate the password corresponding to the printing request of the print data with the second password input by the external apparatus; and a data analysis unit configured to analyze the print data based on a result of the collation of the password corresponding to the printing request of the print data with the second password.

### BACKGROUND OF THE INVENTION

1. Field of the Invention

The present invention relates to an image processing apparatus, a control method thereof, and a computer-readable storage medium storing computer-executable instructions.

2. Description of the Related Art

In an information society, those who handle documents must be concerned about leakage of information, irrespective of a profit or nonprofit organization. For example, a company is required to carry out strict safety management of information that the company owns. Measures must be taken to discard unnecessary print products by a shredder or solution processing.

At an office automation (OA) corner of a printing house or a company, sometimes print products may be left unprotected in terms of personal information protection and confidential information protection. Particularly, at a place of large-volume printing such as variable data publishing (VDP), great volumes of print products containing personal information and confidential information may be output and left.

In such a case, the print product containing the personal information or the confidential information may be directly brought outside, resulting in information leakage. A worker may memorize the personal information of the print product to abuse it. Thus, to prevent information leakage, higher confidentiality is required regarding a print containing personal information or confidential information.

As a technology for preventing information leakage, for example, Japanese Patent Application Laid-Open No. 2003-296052 discusses an image processing apparatus that performs insert synthesis to synthesize an insert form with an insert image based on image data of a processing job or a drawing command input from an image processing terminal.

Specifically, the image processing apparatus performs image synthesis by using form data where a pass code is set or insert data where a password is set, and encrypts the synthesized data to store it. When an output request of the synthesized data is input, the image processing apparatus performs authentication by using the password, and decrypts the encrypted synthesized data based on a result of the authentication to output the print data.

Future expansion of a print-on-demand (POD) market maybe accompanied by more exchange of data such as personalized print markup language (PPML) format data, a VDP format data, or a potable document format (PDF) data containing personal information. For example, in the PDF, a plurality of restrictions can be imposed on files, and an attribute of printing restrictions can be added. Particularly, when PDF data contains personal information or confidential information, to prevent information leakage, printing restrictions may be imposed on the PDF data itself.

The image processing apparatus discussed in Japanese Patent Application Laid-Open No. 2003-296052 performs authentication by using the password when the output request of the encrypted synthesized data is input. However, the image processing apparatus cannot perform the authentication before analysis of print data such as PDF data input to the image processing apparatus, i.e., before the print data is converted into intermediate data.

As a result, the image processing apparatus cannot perform printing for print data to be input, which is imposed print restrictions such as encryption on the print data itself. The image processing apparatus discussed in Japanese Patent Application Laid-Open No. 2003-296052 cannot change print attributes such as a paper size or color setting while maintaining confidentiality of the print data. The image processing apparatus discussed in Japanese Patent Application Laid-Open No. 2003-296052 can display neither a thumbnail of the print data nor the data on a full screen while maintaining the confidentiality of the print data.

### SUMMARY OF THE INVENTION

The present invention is directed to an image processing apparatus, a control method thereof, and a computer-readable storage medium storing computer-executable instructions capable of analyzing encrypted print data while maintaining confidentiality.

According to an aspect of the present invention, there is provided an information processing apparatus including a data reception unit configured to receive print data containing a first password including a password corresponding to at least a printing request of the print data and store the print data in a predetermined storage unit, an encryption determination unit configured to determine, when an external apparatus makes a printing request of the print data, whether the print data has been encrypted, a password request unit configured to make, when the print data is determined to have been encrypted, an input request of a second password to the external apparatus that has made the printing request of the print data, a password collation unit configured to collate the password corresponding to the printing request of the print data included in the first password in the print data stored in the storage unit with the second password input by the external apparatus, and a data analysis unit configured to analyze the print data based on a result of the collation of the password corresponding to the printing request of the print data with the second password.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B respectively illustrate an example system configuration and an example configuration of an image control apparatus.

FIG. 2 illustrates an example of a password setting screen on a host computer.

FIG. 3 illustrates an example of a processing request setting screen on the host computer.

FIG. 4 illustrates an operation processing example of the image control apparatus according to an exemplary embodiment.

FIGS. 5A to 5D illustrate examples of password input screens.

FIG. 6 is a flowchart illustrating an operation processing flow of an image control apparatus according to a first exemplary embodiment.

FIG. 7 is a flowchart illustrating an operation processing flow of an image control apparatus according to a second exemplary embodiment.

FIG. 8 is a flowchart illustrating an operation processing flow of an image control apparatus according to a third exemplary embodiment.

FIG. 9 is a flowchart illustrating an operation processing flow of an image control apparatus according to a fourth exemplary embodiment.

### DESCRIPTION OF THE EMBODIMENTS

Various exemplary embodiments, features, and aspects of the invention will be described in detail below with reference to the drawings.

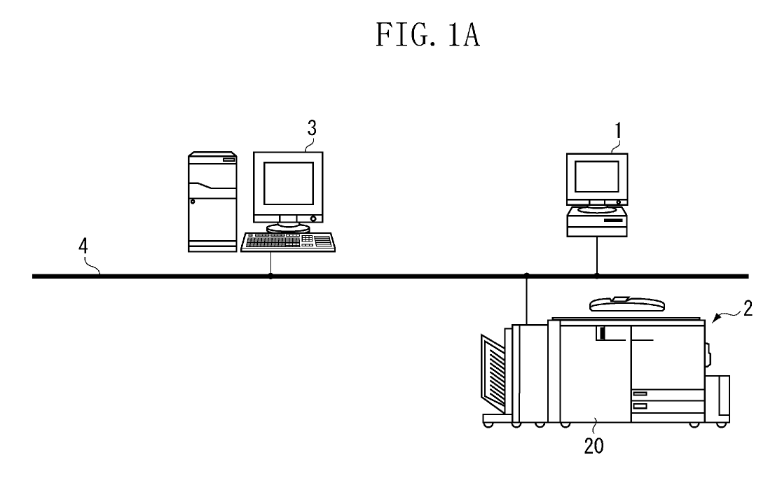

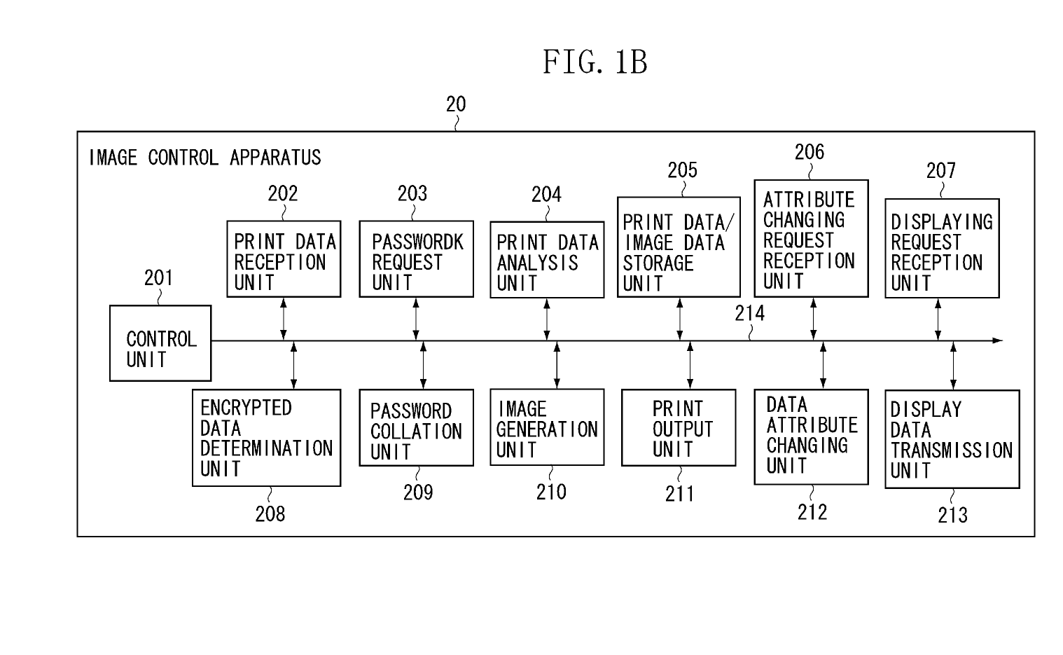

FIGS. 1A and 1B respectively illustrate an example system configuration and an example configuration of an image control apparatus. FIG. 1A illustrates the example system configuration. The system illustrated in FIG. 1A includes host computers 1 and 3, and a printing apparatus 2.

Each host computer is connected to an image control apparatus 20 included in the printing apparatus 2 via a network 4. The host computers 1 and 3 are similar in function. FIG. 1A illustrates the two host computers. However, the system can include one or two or more host computers.

The host computers 1 and 3 are external apparatuses disposed outside the printing apparatus 2. The host computer 1 has functions of editing an application file and making various processing requests including a printing request of print data to the image control apparatus 20. The printing request of the print data is for printing the print data.

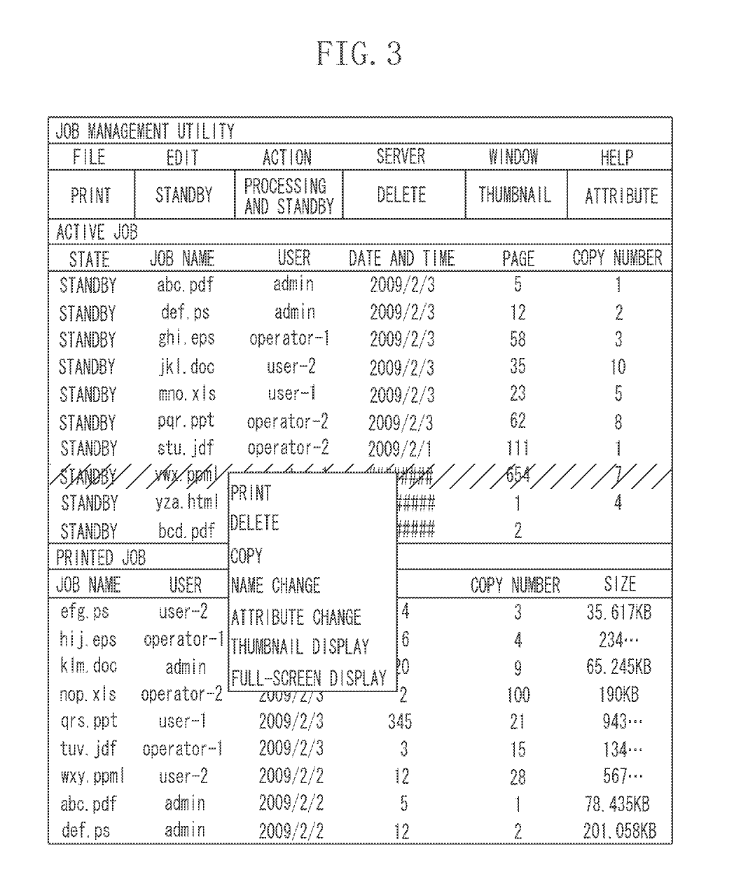

Thus, the host computer 1 includes a job management utility for making a processing request to the image control apparatus 20. An example of the processing request made by the job management utility will be described below referring to a processing request setting screen illustrated in FIG. 3.

The host computer 1 has a function of making, in addition to the printing request, an attribute changing request of data managed by the image control apparatus 20 and a displaying request in a predetermined display format of data. The attribute changing request of the data is for changing an attribute of one of the print data and the image data. The attribute changing request of the data is for changing, for example, setting of a paper size or color setting when the data is printed.

The displaying request in the predetermined display format of the data is for generating display data of the predetermined display format for one of the print data and the image data, and transmitting the generated display data to the host computer 1. The displaying request is, for example, a thumbnail displaying request.

The thumbnail displaying request is made to the image control apparatus 20 to display a thumbnail of one of the print data and the image data. The displaying request can be a full-screen displaying request.

The full-screen displaying request is made to the image control apparatus 20 to display one of the print data and the image data on a full screen. In other words, the full-screen displaying request is for transmitting full-screen data. The full-screen data is image data for full-screen displaying.

The printing apparatus 2 has various functions such as scanning, printing, and copying. The printing apparatus 2 includes the image control apparatus 20. The image control apparatus 20 is an example of the image processing apparatus according to the exemplary embodiment, which performs image generation, and printing, and outputting for the input print data.

The image control apparatus 20 receives, via the network 4, an attribute changing request of the print data from one of the host computers 1 and 3, determines whether to permit attribute changing of the print data, and returns a result of the determination to the host computer that has made the attribute changing request.

The image control apparatus 20 receives, via the network 4, a displaying request in a predetermined display format of data from one of the host computers 1 and 3, generates display data of the predetermined display format, and transmits the display data to the host computer that has made the displaying request.

FIG. 1B is a block diagram illustrating an example configuration of the image control apparatus 20. The example configuration of the image control apparatus 20 illustrated in FIG. 1B is applied to first to fourth exemplary embodiments of the present invention described below. The image control apparatus 20 includes a control unit 201, a print data reception unit 202, a password request unit 203, a print data analysis unit 204, a print data/image data storage unit 205, and an attribute changing request reception unit 206.

The image control unit 20 further includes a displaying request reception unit 207, an encrypted data determination unit 208, a password collation unit 209, an image generation unit 210, a print output unit 211, a data attribute changing unit 212, and a display data transmission unit 213. A method of controlling the information processing apparatus of the exemplary embodiment and a computer program thereof are realized by functions of the processing units included in the image control apparatus 20 illustrated in FIG. 1B.

The control unit 201 controls each processing unit connected via a system bus 214, and controls an overall operation of the image control apparatus 20. The print data reception unit 202 receives print data and a printing request of the print data input from the host computer (the host computers 1 or 3).

The print data reception unit 202 may separately receive the print data and the printing request. The separate reception is allowed because the host computer may make a printing request of the transmitted print data to the image control apparatus 20. The print data includes a first password.

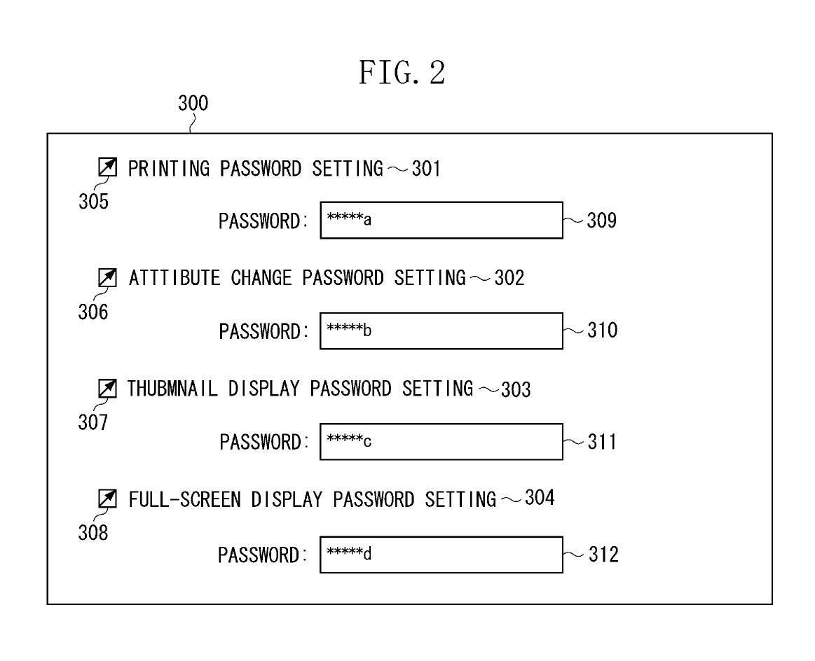

In the present exemplary embodiment, the first password includes a password corresponding to the printing request of the print data, a password corresponding to an attribute changing request of the print data or the image data, and a password corresponding to a displaying request of the print data or the image data in a predetermined display format. In the exemplary embodiment, the host computer sets the first password for the print data according to a user's operation input on a password setting screen illustrated in FIG. 2.

The print data reception unit 202 stores the received print data in the print data/image data storage unit 205. In other words, the print data reception unit 202 functions as a data reception unit configured to receive the print data including the first password including at least the password corresponding to the printing request of the print data, and store the print data in a predetermined storage unit (print data/image data storage unit 205).

The print data reception unit 202 transmits the received print data to the encrypted data determination unit 208. The print data reception unit 202 receives a password transmitted from the host computer in response to a password request made by the password request unit 203 described below, and transmits the received password to the password collation unit 209.

When the print data reception unit 202 receives the printing request, the encrypted data determination unit 208 determines whether the print data corresponding to the printing request has been encrypted. More specifically, the encrypted data determination unit 208 functions as an encrypted data determination unit to determine whether the print data has been encrypted when the external apparatus (host computer) makes the printing request of the print data.

The encrypted data determination unit 208 determines whether the print data or the image data corresponding to the attribute changing request received by the attribute changing request reception unit 206 from the host computer has been encrypted. The encrypted data determination unit 208 determines whether the print data or the image data corresponding to the displaying request received by the displaying request reception unit 207 from the host computer has been encrypted.

The password request unit 203 functions as a request unit configured to make a password input request to the host computer according to a result of the determination executed by the encrypted data determination unit 208 as to whether the print data has been encrypted.

Specifically, when the encrypted data determination unit 208 determines that the print data received together with the printing request has been encrypted, the password request unit 203 requests the host computer that has made the printing request to input a password (second password).

When the encrypted data determination unit 208 determines that the print data or the image data corresponding to the attribute changing request has been encrypted, the password request unit 203 requests the host computer that has made the attribute changing request to input a password (third password).

When the encrypted data determination unit 208 determines that one of the print data and the image data corresponding to the displaying request has been encrypted, the password request unit 203 requests the host computer that has made the displaying request to input a password (fourth password).

The password collation unit 209 functions as a collation unit configured to collate the password corresponding to the printing request included in the first password in the print data or the image data stored by the print data/image data storage unit 205 with the second password input to the image control apparatus 20 by the host computer.

The password collation unit 209 collates the password corresponding to the attribute changing request included in the first password in the print data or the image data stored by the print data/image data storage unit 205 with the third password input by the host computer.

The password collation unit 209 collates the password corresponding to the displaying request included in the first password in the print data or the image data stored on the print data/image data storage unit 205 with the fourth password input by the host computer.

The print data analysis unit 204 analyzes the print data received by the print data reception unit 202. Specifically, the print data analysis unit 204 analyzes the print data when the password collation unit 209 determines that the password corresponding to the printing request of the print data matches the second password. The print data analysis unit 204 transmits a result of analyzing the print data to the image generation unit 210 or the print output unit 211.

More specifically, the print data analysis unit 204 functions as an analysis unit configured to analyze the print data based on the collation result of the password corresponding to the printing request of the print data with the second password.

The image generation unit 210 generates image data based on the analysis result of the print data received from the print data analysis unit 204. The image generation unit 210 transmits the generated image data to the print output unit 211 and the print data/image data storage unit 205.

When the password collation unit 209 determines that the password corresponding to the displaying request matches the fourth password, the image generation unit 210 functions as a display image generation unit configured to generate data of a display format corresponding to the displaying request as display data. Specifically, the image generation unit 210 generates display data having the display format corresponding to the displaying request based on the print data or the image data stored by the print data/image data storage unit 205.

The print data/image data storage unit 205 stores the print data received by the print data reception unit 202. The print data/image data storage unit 205 stores the image data generated by the image generation unit 210. The image data contains the first password in the print data that is a generation source of the image data.

Thus, the password collation unit 209 can collate, according to a processing request from the host computer 1, the first password in the image data stored by the print data/image data storage unit 205 with the third or fourth password.

The print output unit 211 receives the image data from the image generation unit 210, and prints and outputs the received image data. The attribute changing request reception unit 206 functions as an attribute changing request reception unit configured to receive an attribute changing request from the host computer. In the present exemplary embodiment, the attribute changing request is the print data or the image data stored on the print data/image data storage unit 205.

The data attributes changing unit 212 functions as an attributes changing unit configured to determine whether to permit attribute changing of the print data or the image data corresponding to the attribute changing request made by the host computer, and return a result of the determination to the host computer. Specifically, the data attribute changing unit 212 determines whether to permit attribute changing of data corresponding to the attribute changing request based on the collation result of the password corresponding to the attribute changing request with the third password executed by the password collation unit 209.

The data attribute changing unit 212 receives information regarding a new attribute from the host computer permitted to change the attribute, and changes the attribute (e.g., paper size setting or color setting) of the print data or the image data based on the information. Specifically, the data attribute changing unit 212 instructs the print data analysis unit 204 to analyze the print data by using the received information regarding the new attribute.

The displaying request reception unit 207 functions as a displaying request reception unit configured to receive a displaying request of the display data of the predetermined display format from the host computer. In the present exemplary embodiment, the displaying request is for transmission of the display data of the predetermined display format concerning the print data or the image data stored on the print data/image data storage unit 205.

The display data transmission unit 213 functions as a data transmission unit configured to transmit the display data of the predetermined format generated by the image generation unit 210 in response to the displaying request to the host computer that has made the displaying request.

FIG. 2 illustrates an example of a password setting screen of the host computer. The password setting screen is used to set the first password for the print data. In the present exemplary embodiment, a password setting screen 300 displayed by the host computer 1 is described.

To encrypt the print data to be transmitted to the image control apparatus 20, the host computer 1 sets a password on the password setting screen 300 illustrated in FIG. 2. In the present exemplary embodiment, the host computer 1 can perform four password setting operations, i.e., printing password setting 301, attribute change password setting 302, thumbnail display password setting 303, and full-screen display password setting 304.

Corresponding to these password setting operations, there are provided a check box 305, a check box 306, a check box 307, and a check box 308. Corresponding to the password setting operations, password input sections 309, 310, 311, and 312 are provided.

The password input section 309 is for inputting a printing password. The printing password corresponds to a printing request. The password input section 310 is for inputting an attribute change password. The attribute change password corresponds to an attribute changing request.

The password input section 311 is for inputting a thumbnail display password. The thumbnail display password corresponds to a thumbnail displaying request. The password input section 312 is for inputting a full-screen display password. The full-screen display password corresponds to a full-screen displaying request.

When a user checks the check box corresponding to desired password setting, and inputs a password to the password setting section, the host computer 1 sets a password, and encrypts the print data based on the set password. The host computer 1 transmits, to the image control apparatus 20, the encrypted print data including a setting content of the password set on the password setting screen.

FIG. 3 illustrates an example of a processing request setting screen of the host computer. The processing request setting screen is used to set a processing content that the host computer 1 requests to the image control apparatus 20. In the present exemplary embodiment, the processing request setting screen shows a processing content that a job management utility installed in the host computer 1 can execute for a vwx.ppml file stored on the print data/image data storage unit 205.

More specifically, when the user moves a cursor to the vwx.ppml file on the processing request setting screen, as illustrated in FIG. 3, processing contents such as “PRINT”, “DELETE”, “COPY”, “NAME CHANGE”, “ATTRIBUTE CHANGE”, “THUMBNAIL DISPLAY”, and “FULL-SCREEN DISPLAY” are displayed. The “PRINT” indicates a printing request of the vwx.ppml file. The “DELETE” indicates a deleting request of the vwx.ppml file.

The “COPY” indicates a copying request of the vwx.ppml file. The “NAME CHANGE” indicates a changing request of a name of the vwx.ppml file. The “THUMBNAIL DISPLAY” indicates a thumbnail displaying request of the vwx.ppml file. The “FULL-SCREEN DISPLAY” indicates a full-screen displaying request of the vwx.ppml file. When the user selects a desired processing content on the processing request setting screen, the job management utility sets a processing request indicating the selected processing content. The job management utility transmits the set processing request to the image control apparatus 20.

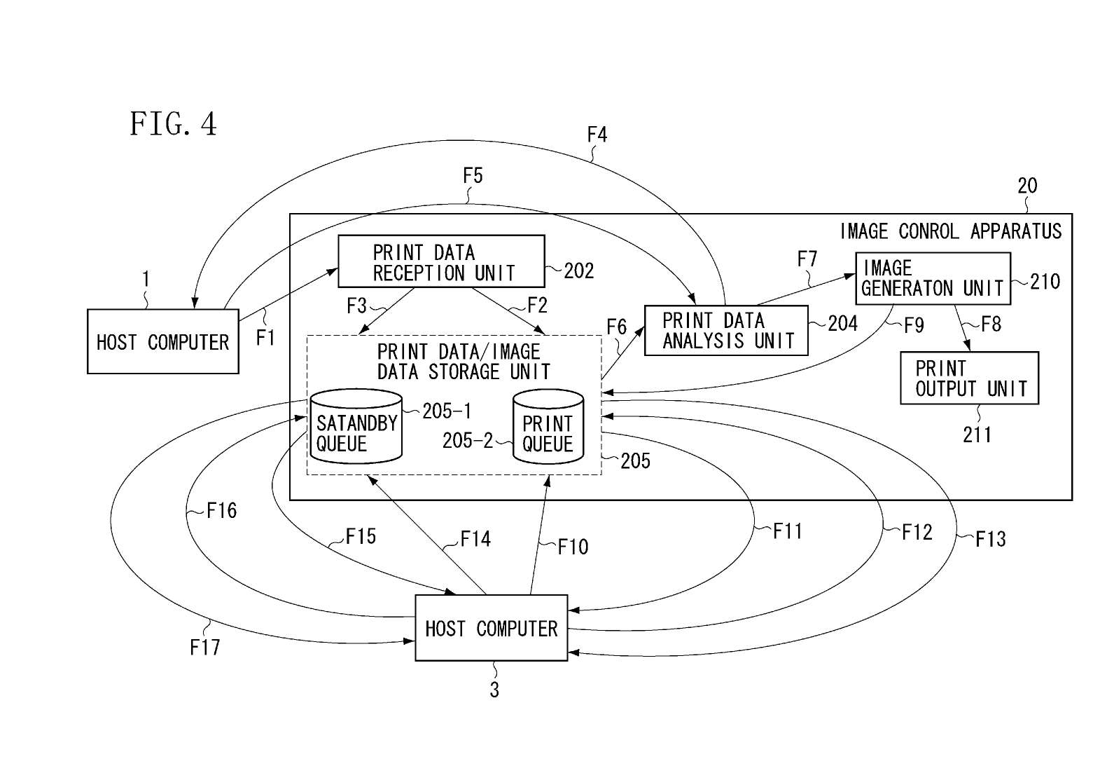

FIG. 4 illustrates an operation processing example of the image control apparatus according to the exemplary embodiment. First, processing when the host computer 1 requests printing of the encrypted print data is described.

The host computer 1 transmits, integrally with the encrypted print data, a printing request of the print data to the image control apparatus 20 (F1 illustrated in FIG. 4). The print data reception unit 202 stores the received print data in a print queue 205-2 included in the print data/image data storage unit 205 (F2 illustrated in FIG. 4). The print queue 205-2 is for storing the print data to be printed and the image data generated by the image generation unit 210.

When there is no printing request of the received print data, the print data reception unit 202 stores the print data in a standby queue 205-1 (F3 illustrated in FIG. 4). The standby queue 205-1 is for directly storing the received print data without setting the data as a printing target.

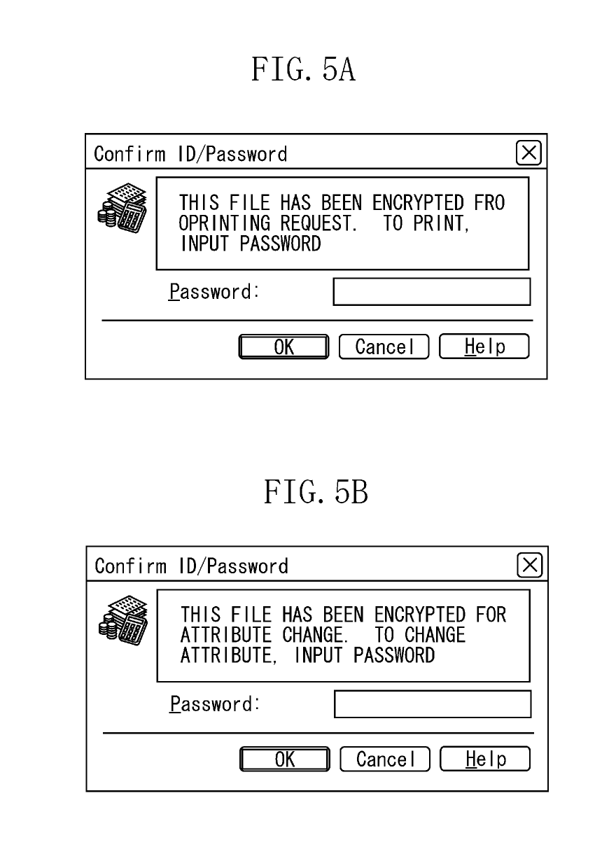

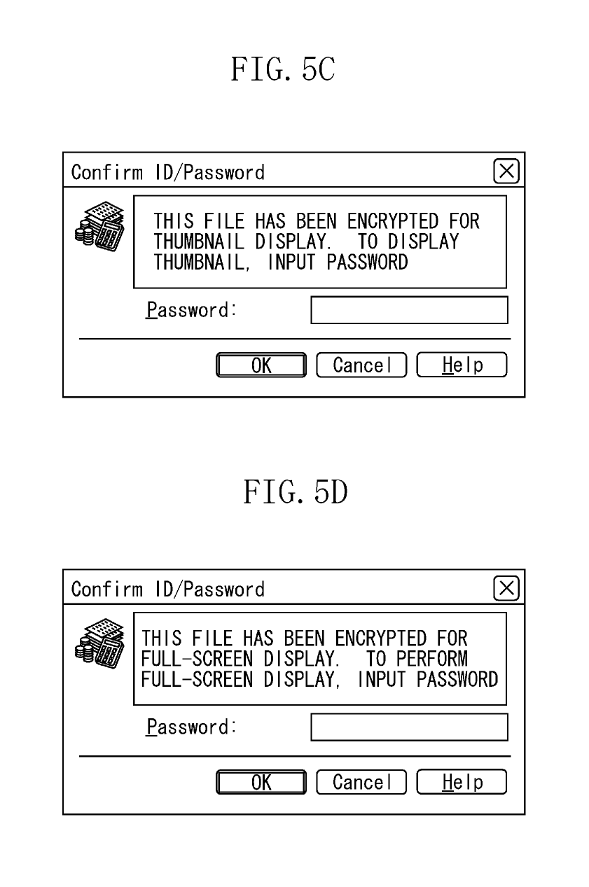

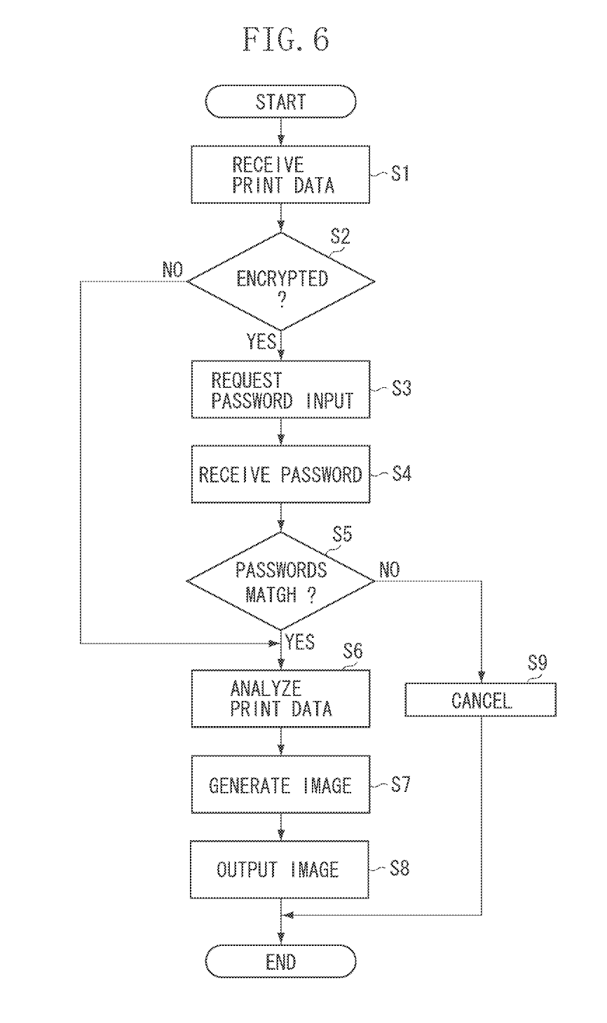

The password request unit 203 illustrated in FIG. 1B requests, before the print data arrives at the print data analysis unit 204, a printing password to the host computer 1 (F4 illustrated in FIG. 4). The host computer 1 that has received the printing password request from the password request unit 203 displays a password input screen illustrated in FIG. 5A.

When the user of the host computer 1 inputs a password on the password input screen illustrated in FIG. 5A to press an “OK” button, the host computer 1 transmits the input password to the image control apparatus 20 (F5 illustrated in FIG. 4). The password collation unit 209 of the image control apparatus 20 illustrated in FIG. 1B determines whether the password transmitted from the host computer 1 matches the printing password in the print data corresponding to the printing request stored in the print queue 205-2.

When the password collation unit 209 determines that the password transmitted from the host computer 1 matches the printing password in the print data, the print data analysis unit 204 extracts the print data from the print queue 205-2 to analyze the print data (F6 illustrated in FIG. 4).

The print data analysis unit 204 transmits an analysis result of the print data to the image generation unit 210 (F7 illustrated in FIG. 4). The image generation unit 210 generates image data based on the analysis result of the print data transmitted from the print data analysis unit 204. The image generation unit 210 transmits the image data to the print output unit 211. The print output unit 211 outputs the print image data (F8 illustrated in FIG. 4).

The image generation unit 210 transmits, according to an instruction from the control unit 201, the image data to the print queue 205-2 and stores it (F9 illustrated in FIG. 4).

Processing when the host computer 3 makes an attribute changing request to the image control apparatus 20 is described. The host computer 3 makes the attribute changing request to the image control apparatus 20 (F10 illustrated in FIG. 4). The password request unit 203 of the image control apparatus 20 illustrated in FIG. 1B requests an attribute change password to the host computer 3 (F11 illustrated in FIG. 4).

The host computer 3 that has received the request of the attribute change password from the password request unit 203 displays the password input screen illustrated in FIG. 5B. When the user of the host computer 3 inputs a password on the password input screen illustrated in FIG. 5B and presses the “OK” button, the host computer 3 transmits the input password to the image control apparatus 20 (F12 illustrated in FIG. 4).

The password collation unit 209 of the image control apparatus 20 illustrated in FIG. 1B determines whether the password transmitted from the host computer 3 matches the attribute change password in the print data or the image data corresponding to the attribute changing request.

The print data corresponding to the attribute changing request is stored in the standby queue 205-1 or the print queue 205-2. The image data corresponding to the attribute changing request is stored in the print queue 205-2.

When the password collation unit 209 determines that the password transmitted from the host computer 3 matches the attribute change password, the data attribute changing unit 212 illustrated in FIG. 1B permits the host computer 3 to change the attribute (F13 illustrated in FIG. 4).

Processing when the host computer 3 makes a displaying request to the image control apparatus 20 is described.

The host computer 3 makes the displaying request to the image control apparatus 20 (F14 illustrated in FIG. 4). In the present exemplary embodiment, the host computer 3 makes a thumbnail displaying request to the image control apparatus 20. The host computer 3 may make a full-screen displaying request to the image control apparatus 20.

The password request unit 203 of the image control apparatus 20 illustrated in FIG. 1B requests a thumbnail display password to the host computer 3 (F15 illustrated in FIG. 4). When the host computer 3 makes the full-screen displaying request to the image control apparatus 20, the password request unit 203 requests a full-screen display password to the host computer 3.

The host computer 3 that has received the request of the thumbnail display password from the password request unit 203 displays a password input screen illustrated in FIG. 5C. When the user of the host computer 3 inputs a password on the password input screen illustrated in FIG. 5C and presses the “OK” button, the host computer 3 transmits the input password to the image control apparatus 20 (F16 illustrated in FIG. 4).

When the host computer 3 receives the request of the full-screen display password from the password request unit 203, the host computer 3 displays a password input screen illustrated in FIG. 5D. When the user of the host computer 3 inputs a password on the password input screen illustrated in FIG. 5D and presses the “OK” button, the host computer 3 transmits the input password to the image control apparatus 20.

The password collation unit 209 of the image control apparatus 20 illustrated in FIG. 1B then determines whether the password transmitted from the host computer 3 matches the thumbnail display password in the print data or the image data corresponding to the displaying request. The print data corresponding to the displaying request is stored in the standby queue 205-1 or the print queue 205-2. The image data corresponding to the displaying request is stored in the print queue 205-2.

In the example illustrated in FIG. 4, the password collation unit 209 determines whether the password transmitted from the host computer 3 matches the thumbnail display password. When the password collation unit 209 determines that the password transmitted from the host computer 3 matches the thumbnail display password, the image generation unit 210 illustrated in FIG. 1B performs the following processing. Specifically, the image generation unit 210 generates image data for thumbnail displaying, and transmits the generated image data to the host computer 3 (F17 illustrated in FIG. 4).

When the displaying request is a full-screen displaying request, the password collation unit 209 determines whether the password transmitted from the host computer 3 matches the full-screen display password. When the password collation unit 209 determines that the password transmitted from the host computer 3 matches the full-screen display password, the image generation unit 210 illustrated in FIG. 1B generates full-screen data, and transmits the generated full-screen data to the host computer 3.

Referring to FIG. 4, the example where the host computer 3 makes the attribute changing request and the displaying request has been described. However, needless to say, the host computer 1 can make an attribute changing request and a displaying request.

FIG. 6 is a flowchart illustrating operation processing of an image control apparatus according to a first exemplary embodiment of the present invention.

The host computer 1 sets a password including a printing password based on a user's operation input on the password setting screen. The host computer 1 transmits encrypted print data containing the set password together with a printing request of the print data to the image control apparatus 20.

In step S1, the print data reception unit 202 of the image control apparatus 20 receives the print data transmitted from the host computer 1. In step S2, the encrypted data determination unit 208 determines whether the received print data has been encrypted.

When the encrypted data determination unit 208 determines that the print data has not been encrypted (NO in step S2), the processing proceeds to step S6. When the encrypted data determination unit 208 determines that the print data has been encrypted (YES in step S2), in step S3, the password request unit 203 requests a printing password to the host computer 1.

In step S4, the print data reception unit 202 receives a password from the host computer 1. In step S5, the password collation unit 209 determines whether the password received in step S4 matches the printing password in the print data received in step S1.

When the password collation unit 209 determines that the password does not match the printing password (NO in step S5), in step S9, the control unit 201 cancels printing of the print data received in step S1. When the password collation unit 209 determines that the password matches the printing password (YES in step S5), the control unit 201 transmits the print data received in step S1 to the print data analysis unit 204. In step S6, the print data analysis unit 204 analyzes the print data.

The print data analysis unit 204 transmits the analyzed print data to the image generation unit 210. In step S7, the image generation unit 210 generates image data. The image generation unit 210 transmits the image data to the print output unit 211 according to an instruction from the control unit 201. In step S8, the print output unit 211 outputs the image data.

In step S8, the image generation unit 210 stores the image data in the print data/image data storage unit 205 according to an instruction from the control unit 201. According to the first exemplary embodiment, the encrypted print data can be analyzed while its confidentiality is maintained.

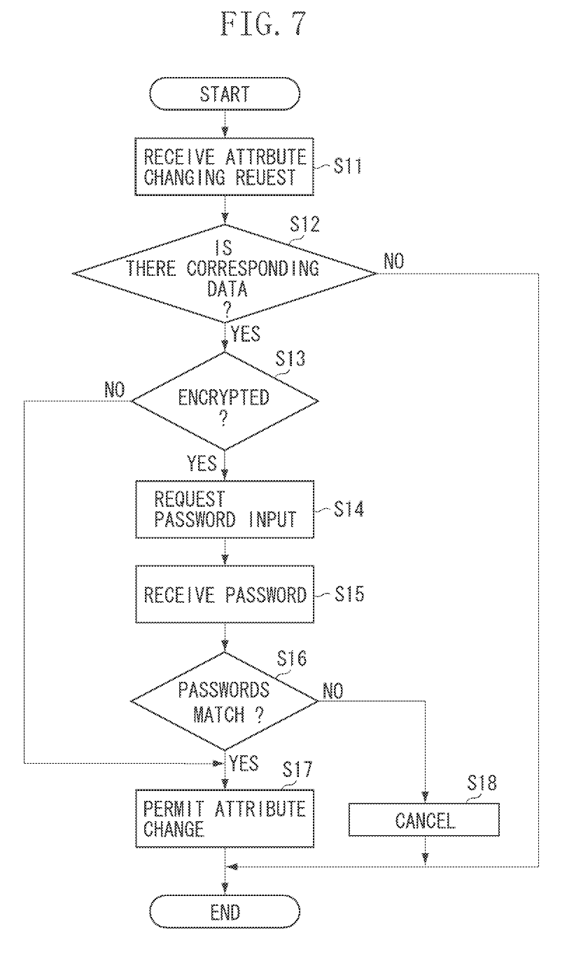

FIG. 7 is a flowchart illustrating operation processing of an image control apparatus according to a second exemplary embodiment of the present invention. The host computer 1 sets an attribute change password based on a user's operation input on the password setting screen. The host computer 1 transmits encrypted print data containing the set attribute change password to the image control apparatus 20.

The print data reception unit 202 of the image control apparatus 20 receives the encrypted print data transmitted from the host computer 1. The print data reception unit 202 stores the received print data in the print data/image data storage unit 205 according to an instruction from the control unit 201.

In step S11, the host computer 1 transmits an attribute changing request to the image control apparatus 20. The host computer 1 obtains, for example, a print attribute such as a paper size or color setting based on the attribute changing request. In step S12, the control unit 201 determines whether there is print data or image data corresponding to the attribute changing request in the print data/image data storage unit 205.

When the control unit 201 determines that there is neither print data nor image data corresponding to the attribute changing request in the print data/image data storage unit 205 (NO in step S12), the processing is terminated. When the control unit 201 determines that there is print data or image data corresponding to the attribute changing request in the print data/image data storage unit 205 (YES in step S12), the encrypted data determination unit 208 performs the following processing.

Specifically, in step S13, the encrypted data determination unit 208 determines whether the print data or the image data corresponding to the attribute changing request has been encrypted. When the encrypted data determination unit 208 determines that none of the print data and the image data has been encrypted (NO in step S13), the processing proceeds to step S17. When the encrypted data determination unit 208 determines that the print data or the image data has been encrypted (YES in step S13), in step S14, the password request unit 203 requests an attribute change password to the host computer 1.

In step S15, the print data reception unit 202 receives a password from the host computer 1. In step S16, the password collation unit 209 determines whether the password received in step S15 matches the attribute change password in the print data or the image data corresponding to the attribute changing request.

When the password collation unit 209 determines that the password does not match the attribute change password (NO in step S16), in step S18, the data attribute changing unit 212 determines not to permit attribute changing of the print data and the image data, and cancels the attribute changing. When the password collation unit 209 determines that the password matches the attribute change password (YES in step S16), in step S17, the data attribute changing unit 212 determines to permit attribute changing of the print data or the image data. According to the second exemplary embodiment, a print attribute such as a paper size or color setting can be changed while confidentiality of the print data is maintained.

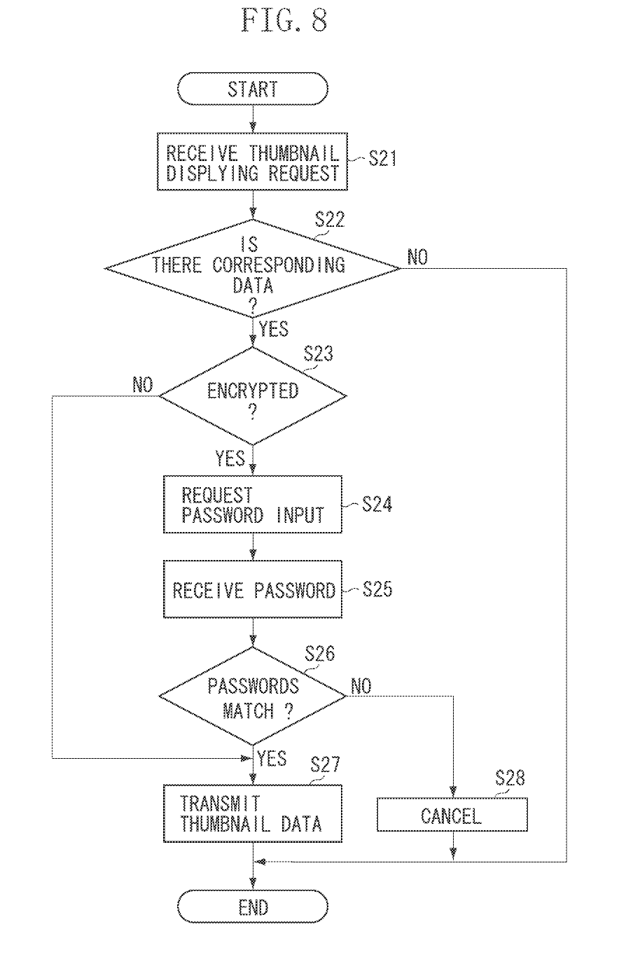

FIG. 8 is a flowchart illustrating operation processing of an image control apparatus according to a third exemplary embodiment of the present invention. The host computer 1 sets a thumbnail display password based on a user's operation input on the password setting screen. The host computer 1 transmits encrypted print data containing the set thumbnail display password to the image control apparatus 20.

The print data reception unit 202 of the image control apparatus 20 receives the encrypted print data transmitted from the host computer 1. The print data reception unit 202 stores the received print data in the print data/image data storage unit 205 according to an instruction from the control unit 201.

In step S21, the host computer 1 transmits a thumbnail displaying request to the image control apparatus 20. In step S22, the control unit 201 determines whether there is any one of print data and image data corresponding to the thumbnail displaying request in the print data/image data storage unit 205.

When the control unit 201 determines that there is neither print data nor image data corresponding to the thumbnail displaying request in the print data/image data storage unit 205 (NO in step S22), the processing is terminated. When the control unit 201 determines that there is the print data or the image data corresponding to the thumbnail displaying request in the print data/image data storage unit 205 (YES in step S22), the encrypted data determination unit 208 performs the following processing. Specifically, in step S23, the encrypted data determination unit 208 determines whether the print data or the image data corresponding to the thumbnail displaying request has been encrypted.

When the encrypted data determination unit 208 determines that none of the print data and the image data has been encrypted (NO in step S23), the processing proceeds to step S27. When the encrypted data determination unit 208 determines that the print data or the image data has been encrypted (YES in step S23), in step S24, the password request unit 203 requests a thumbnail display password to the host computer 1.

In step S25, the print data reception unit 202 receives a password from the host computer 1. In step S26, the password collation unit 209 determines whether the password received in step S25 matches the thumbnail display password in the print data or the image data corresponding to the thumbnail displaying request.

When the password collation unit 209 determines that the password does not match the thumbnail display password (NO in step S26), in step S28, the control unit 201 cancels the thumbnail displaying of one of the print data and the image data. When the password collation unit 209 determines that the password matches the thumbnail display password (YES in step S26), in step S27, the display data transmission unit 213 transmits thumbnail data to the host computer 1.

Specific processing in step S27 is described. When the print data stored in the print data/image data storage unit 205 is of a PDF format, the following processing is executed. The display data transmission unit 213 extracts the print data of the PDF format corresponding to the thumbnail displaying request from the print data/image data storage unit 205, and transmits the extracted print data as thumbnail data to the host computer 1.

When the print data stored in the print data/image data storage unit 205 is of a page description language (PDL) format such as a postscript, the image generation unit 210 executes the following processing.

Specifically, the image generation unit 210 generates image data (thumbnail data) based on the print data stored in the print data/image data storage unit 205. The display data transmission unit 213 transmits the generated thumbnail data to the host computer 1. According to the third exemplary embodiment, the thumbnail data can be displayed while confidentiality of the data stored in the image control apparatus 20 is maintained.

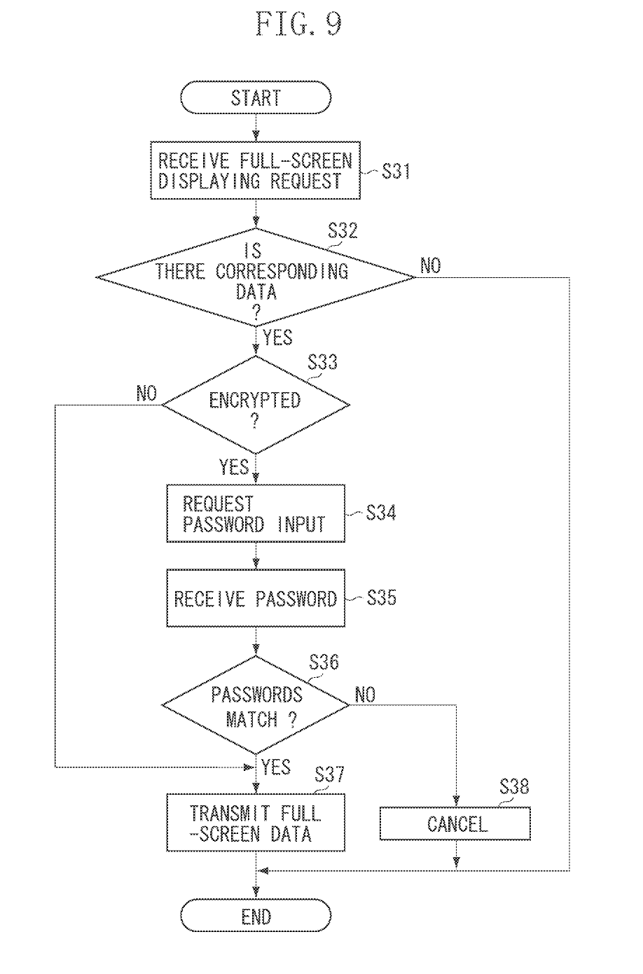

FIG. 9 illustrates an operation processing flow of an image control apparatus according to a fourth exemplary embodiment of the present invention. Processing of steps S31 to S38 of FIG. 9 corresponds to processing of the fourth exemplary embodiment. The processing of the fourth exemplary embodiment is executed through a procedure similar to that of the processing of the third exemplary embodiment described above referring to FIG. 8. However, the fourth exemplary embodiment is different from the third exemplary embodiment in that the image control apparatus 20 receives not a thumbnail displaying request but a full-screen displaying request.

Specifically, in step S31, the image control apparatus 20 receives a full-screen displaying request from the host computer 1. In step S34, the image control apparatus 20 requests a full-screen display password to the host computer 1. When the password received from the host computer 1 matches the full-screen display password in the print data or the image data corresponding to the full-screen displaying request (YES in step S36), in step S37, the image control apparatus 20 generates full-screen data, and transmits the generated full-screen data to the host computer 1. According to the fourth exemplary embodiment, the data can be displayed on a full screen while confidentiality of the data stored in the image control apparatus 20 is maintained.

The present invention can be realized by executing the following processing. Software (program) for realizing the functions of the exemplary embodiments is supplied to a system or an apparatus via a network or various storage media, and a computer (CPU or MPU) of the system or the apparatus reads the program to execute it. In this case, the program and the storage media storing the program are within the invention.

According to the exemplary embodiments of the present invention, the encrypted print data can be analyzed while confidentiality of the data is maintained.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-229465 filed Oct. 1, 2009, which is hereby incorporated by reference herein in its entirety.

What is claimed is:

1. An information processing apparatus comprising:
a data reception unit configured to receive print data containing a first password including a password corresponding to at least a printing request of the print data and store the print data in a predetermined storage unit;
an encryption determination unit configured to determine, when an external apparatus makes a printing request of the print data, whether the print data has been encrypted;
a password request unit configured to make, when the print data is determined to have been encrypted, an input request of a second password to the external apparatus that has made the printing request of the print data;
a password collation unit configured to collate the password corresponding to the printing request of the print data included in the first password in the print data stored in the storage unit with the second password input by the external apparatus; and
a data analysis unit configured to analyze the print data based on a result of the collation of the password corresponding to the printing request of the print data with the second password.

2. The information processing apparatus according to claim 1, further comprising:
an attribute changing request reception unit configured to receive an attribute changing request of data from the external apparatus; and
an attribute change determination unit configured to determine whether to permit attribute changing of data corresponding to the attribute changing request,
wherein the first password includes a password corresponding to the attribute changing request of the data,
wherein the encryption determination unit determines whether the data corresponding to the attribute changing request has been encrypted,
wherein the password request unit makes, when the data corresponding to the attribute changing request is determined to have been encrypted, an input request of a third password to the external apparatus that has made the attribute changing request of the data,
wherein the password collation unit collates the password corresponding to the attribute changing request of the data included in the first password in the data stored in the storage unit with the third password input by the external apparatus, and
wherein the attribute change determination unit determines, based on a result of the collation of the password corresponding to the attribute changing request of the data with the third password, whether to permit attribute changing of the data corresponding to the attribute changing request.

3. The information processing apparatus according to claim 1, further comprising:
a displaying request reception unit configured to receive a displaying request of display data of a predetermined display format from the external apparatus;
a display data generation unit configured to generate data of the predetermined display format corresponding to the displaying request as the display data; and
a data transmission unit configured to transmit the generated display data to the external apparatus,
wherein the first password includes a password corresponding to the displaying request,
wherein the encryption determination unit determines whether the data corresponding to the displaying request has been encrypted,
wherein the password request unit makes, when the data corresponding to the displaying request is determined to have been encrypted, an input request of a fourth password to the external apparatus that has made the displaying request,
wherein the password collation unit collates the password corresponding to the displaying request included in the first password in the data stored in the storage unit with the fourth password input by the external apparatus, and
wherein the display data generation unit generates, based on a result of the collation of the password corresponding to the displaying request with the fourth password, the display data of the predetermined display format corresponding to the displaying request.

4. The information processing apparatus according to claim 3, wherein the displaying request is for displaying a thumbnail of the data.

5. The information processing apparatus according to claim 3, wherein the displaying request is for displaying the data on a full screen.

6. A method for controlling an information processing apparatus, comprising:
receiving print data containing a first password including a password corresponding to at least a printing request of the print data and storing the print data in a predetermined storage unit;
determining, when an external apparatus makes a printing request of the print data, whether the print data has been encrypted;
making, when the print data is determined to have been encrypted, an input request of a second password to the external apparatus that has made the printing request of the print data;
collating the password corresponding to the printing request of the print data included in the first password in the print data stored in the storage unit with the second password input by the external apparatus; and
analyzing the print data based on a result of the collation of the password corresponding to the printing request of the print data with the second password.

7. A non-transitory computer-readable storage medium storing computer-executable instructions which, when executed by a computer, cause the computer to perform operations comprising:
receiving print data containing a first password including a password corresponding to at least a printing request of the print data and storing the print data in a predetermined storage unit;
determining, when an external apparatus makes a printing request of the print data, whether the print data has been encrypted;
making, when the print data is determined to have been encrypted, an input request of a second password to the external apparatus that has made the printing request of the print data;
collating the password corresponding to the printing request of the print data included in the first password in the print data stored in the storage unit with the second password input by the external apparatus; and
analyzing the print data based on a result of the collation of the password corresponding to the printing request of the print data with the second password.
